(19) United States
(12) Patent Application Publication
(10) Pub. No.: US 2022/0374009 A1
(43) Pub. Date: Nov. 24, 2022

(54) SYSTEM AND METHOD FOR DISPLAYING ELEMENTS OF AN APPLICATION IN SPLIT-SCREEN VIEW

(71) Applicant: ideaForge Technology Pvt. Ltd., Mumbai (IN)

(72) Inventors: Ashish BHAT, Mumbai (IN); Chandan SINGH, Mumbai (IN); Dhirendra SARUP, Mumbai (IN)

(21) Appl. No.: 17/749,011

(22) Filed: May 19, 2022

(30) Foreign Application Priority Data
May 21, 2021 (IN) 202121022824

(51) Int. Cl. G05D 1/00; H04N 7/18; H04N 5/262

(52) U.S. Cl. CPC G05D 1/0038; H04N 7/185; H04N 5/2628; H04N 5/2624

(57) ABSTRACT

The present disclosure provides system and method for displaying a plurality of elements of at least one application on a display screen. An aspect of the present disclosure pertains to a method for displaying the plurality of elements of the at least one application on the display screen, the method including the steps of splitting, at a computing device, the display screen into a plurality of sections, associating, at the computing device, at least one section of the plurality of sections with at least one element of the plurality of elements of the at least one application, controlling, at the computing device, at least one display parameter of the at least one section, and displaying, at the computing device, the at least one element on the display screen in split-screen view.

### TECHNICAL FIELD

The present disclosure relates generally to the field of display devices, and more particularly to systems and methods for displaying elements of an application on a display screen in split-screen view.

### BACKGROUND OF THE INVENTION

Background description includes information that may be useful in understanding the present invention. It is not an admission that any of the information provided herein is prior art or relevant to the presently claimed invention, or that any publication specifically or implicitly referenced is prior art.

A display device is an output device for presentation of information in visual or tactile form. When input information supplied to the display device is in the form of an electrical signal, the display is termed as an electronic display. The ability to provide efficient and intuitive interaction between computing devices and users thereof is essential for delivering an engaging and enjoyable user-experience. Graphical user-interfaces (GUI) are commonly used for facilitating interaction between an operating user and the computing device. Generally, a GUI includes an input means for allowing a user to manipulate objects shown on an associated display screen, and an output means for allowing the computing device to illustrate the effects of the manipulation.

Conventional systems and methods for displaying elements of multiple applications on a display screen tend to display the elements of applications except for instantaneously executed applications as a background layer. In order to display the applications that are in the background layer most computing devices employ an icon based user interface to display the applications present in the background layer. However, such conventional systems and methods prove to be inconvenient and non-user friendly for simultaneously displaying the elements of a single application on the display screen in split-screen view.

Efforts have been made in the past to overcome the above stated problems associated with the display devices. For example, conventional techniques for displaying elements of multiple applications on the display screen incorporate sharing of a display area of the display screen among various executed applications by dividing the display screen into multiple regions and displaying the elements of the executed applications on the display screen. However, such techniques do not provide for simultaneous display of elements of a single application in the display screen in split-screen view.

There is therefore a need to overcome above illustrated problems associated with display devices, and to provide a convenient and user friendly system and method to provide for simultaneous displaying of multiple elements of a single application on a display screen in split-screen view.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

In some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all groups used in the appended claims.

### OBJECTS OF THE INVENTION

A general object of the present disclosure is to provide system and method for displaying of a plurality of elements of an application on a display screen in split-screen view.

Another object of the present disclosure is to provide system and method for positioning of a plurality of sections of a display region of the display screen.

Yet another object of the present disclosure is to provide system and method incorporating control options for modification of various display parameters of the display screen.

Still another object of the present disclosure is to provide convenient and user friendly system and method for simultaneously displaying the elements of an application on the display screen.

These and other objects of the present invention will become readily apparent from the following detailed description taken in conjunction with the accompanying drawings.

### SUMMARY

The present disclosure relates to systems and methods for displaying a plurality of elements of at least one application on a display screen. An aspect of the present disclosure pertains to a method for displaying the plurality of elements of the at least one application on the display screen, the method including the steps of (i) splitting, at a computing device, the display screen into a plurality of sections, (ii) associating, at the computing device, at least one section of the plurality of sections with at least one element of the plurality of elements of the at least one application, wherein the association is based on any or a combination of a set of instructions derived from a user and a pre-configured dataset pertaining to association of the at least one section with the at least one element, (iii) controlling, at the computing device, at least one display parameter of the at least one section, and (iv) displaying, at the computing device, the at least one element on the display screen.

In an embodiment, the method further includes a step of positioning the at least one section to a desired location of the display screen.

In an embodiment, the method further includes a step of controlling at least one parameter associated with the at least one element of the at least one application.

Another aspect of the present disclosure pertains to a system for displaying a plurality of elements of at least one application on a display screen, the system including a non-transitory storage device having embodied therein one or more routines operable to display the plurality of elements of the at least one application on the display screen and one or more processors coupled to the non-transitory storage device, wherein the one or more routines include a display screen split module, which when executed by the one or more processors, splits the display screen into a plurality of sections, an element association module, which when executed by the one or more processors, associates at least one of the plurality of sections with at least one of the plurality of elements of the at least one application, wherein the association is based on any or a combination of a set of instructions derived from a user and a pre-configured dataset pertaining to association of the at least one section with the at least one element, a section control module, which when executed by the one or more processors, controls at least one display parameter of the at least one section and an element display module, which when executed by the one or more processors, displays the at least one element of the at least one application on the display screen in split-screen view.

In an embodiment, the section control module is configured to position the at least one section to a desired location of the display screen.

In an embodiment, the at least one display parameter comprises any or a combination of pixel density, height, width, scaling ratio and pixel location of the at least one of the plurality of sections.

In an embodiment, the section control module is configured to control at least one parameter associated with the at least one element of the at least one application.

In an embodiment, the element display module simultaneously displays the at least one element in split-screen view.

In an embodiment, the section control module allows switching of position of different sections of the plurality of sections.

Various objects, features, aspects and advantages of the inventive subject matter will become more apparent from the following detailed description of preferred embodiments, along with the accompanying drawing figures in which like numerals represent like components.

Those skilled in the art will further appreciate the advantages and superior features of the disclosure together with other important aspects thereof on reading the detailed description that follows in conjunction with the drawings.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates an exemplary architectural representation of proposed system for displaying a plurality of elements of at least one application on a display screen in accordance to an embodiment of the present disclosure.

FIG. 2 illustrates an exemplary representation of various modules of the proposed system for displaying a plurality of elements of at least one application on a display screen in accordance to an embodiment of the present disclosure.

FIG. 3 illustrates an exemplary representation of the plurality of elements of a single application displayed on the display screen in accordance to an embodiment of the present disclosure.

FIG. 4 illustrates an exemplary representation of proposed method for displaying the plurality of elements of the at least one application on the display screen in accordance to an embodiment of the present disclosure.

FIGS. 5A through 5D illustrate exemplary photographic representations showing a display screen displaying multiple elements of an application in split-screen view in accordance with embodiments of the present disclosure.

### DETAILED DESCRIPTION

The following is a detailed description of embodiments of the disclosure depicted in the accompanying drawings. The embodiments are in such details as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

The present disclosure relates to systems and methods for displaying a plurality of elements of at least one application on a display screen. An aspect of the present disclosure pertains to a method for displaying the plurality of elements of the at least one application on the display screen, the method including the steps of (i) splitting, at a computing device, the display screen into a plurality of sections, (ii) associating, at the computing device, at least one section of the plurality of sections with at least one element of the plurality of elements of the at least one application, wherein the association is based on any or a combination of a set of instructions derived from a user and a pre-configured dataset pertaining to association of the at least one section with the at least one element, (iii) controlling, at the computing device, at least one display parameter of the at least one section, and (iv) displaying, at the computing device, the at least one element on the display screen.

In an embodiment, the method further includes a step of positioning the at least one section to a desired location of the display screen.

In an embodiment, the method further includes a step of controlling at least one parameter associated with the at least one element of the at least one application.

Another aspect of the present disclosure pertains to a system for displaying a plurality of elements of at least one application on a display screen, the system including a non-transitory storage device having embodied therein one or more routines operable to display the plurality of elements of the at least one application on the display screen and one or more processors coupled to the non-transitory storage device, wherein the one or more routines include a display screen split module, which when executed by the one or more processors, splits the display screen into a plurality of sections, an element association module, which when executed by the one or more processors, associates at least one of the plurality of sections with at least one of the plurality of elements of the at least one application, wherein the association is based on any or a combination of a set of instructions derived from a user and a pre-configured dataset pertaining to association of the at least one section with the at least one element, a section control module, which when executed by the one or more processors, controls at least one display parameter of the at least one section and an element display module, which when executed by the one or more processors, displays the at least one element of the at least one application on the display screen in split-screen view.

In an embodiment, the section control module is configured to position the at least one section to a desired location of the display screen.

In an embodiment, the at least one display parameter comprises any or a combination of pixel density, height, width, scaling ratio and pixel location of the at least one of the plurality of sections.

In an embodiment, the section control module is configured to control at least one parameter associated with the at least one element of the at least one application.

In an embodiment, the element display module simultaneously displays the at least one element in split-screen view.

In an embodiment, the section control module allows switching of position of different sections of the plurality of sections.

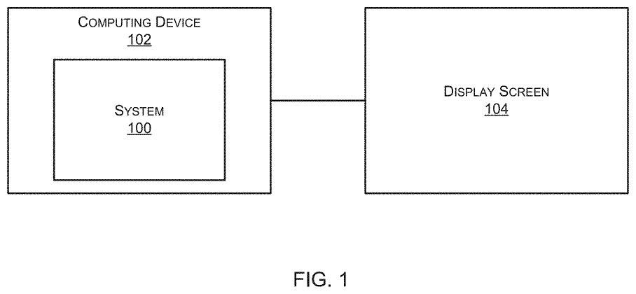

FIG. 1 illustrates an exemplary architectural representation of proposed system for displaying a plurality of elements of at least one application on a display screen in accordance to an embodiment of the present disclosure. In an aspect, the proposed system 100 can enable display of the plurality of elements of a single application in a plurality of sections of a display region of the display screen 104. In another aspect, the system 100 can enable display of the plurality of elements of multiple applications in the plurality of sections of the display region of the display screen 104. In an exemplary aspect, the present disclosure relates to a UAV's Ground Control System's GUI (graphical user interface).

In an aspect, the system 100 can be configured with a computing device 102 either interfaced with the display screen 104 or forming a part of a display device that includes the display screen 104. In an embodiment, the computing device 102 can include any of a computer, a laptop, a controller, a network device, a mobile device, a personal digital assistant (PDA) and the like devices. In an embodiment, the computing device 102 can be interfaced with the display screen 104 by any or a combination of a wired connection and a wireless connection. In an instance, the computing device 102 can be interfaced with the display screen 104 by a Wide Area Network (WAN) connection or any other suitable wireless connection. In another instance, the computing device 102 can be interfaced with the display screen 104 by a Local Area Network (LAN) connection or any other suitable wired connection.

In an aspect, the system 100 can enable splitting of the display screen 104 into the plurality of sections. In an embodiment, the system 100 can receive set of commands pertaining to splitting of the display screen 104 into the plurality of sections for displaying at least one element of the plurality of elements of at least one application in split-screen view. In an embodiment, the set of commands pertaining to the splitting of the display screen can be based on a user input, for instance, touch input, gesture input, mouse input and the like input techniques.

In an aspect, the system 100 can associate each section of the plurality of sections with at least one element of the plurality of elements of the at least one application based on any or a combination of a set of instructions derived from a user and a pre-configured dataset pertaining to association of the at least one section with the at least one element of the at least one application.

In an aspect, the system 100 can control at least one display parameter of at least one section of the plurality of sections of display screen. In an embodiment, the system 100 can modify the at least one display parameter of the at least one section based on any or a combination of a set of instructions derived from the user and pre-defined dataset pertaining to modulation of the at least one display parameter of the at least one section. In an embodiment, the at least one display parameter can be any or a combination of pixel density, height, width, scaling ratio, pixel location and the like parameters of at least one section.

In an embodiment, the set of instructions derived from the user can be in the form of any or a combination of a touch input, a gesture input and a mouse input and other like input techniques. In an embodiment, the pre-configured dataset pertaining to association of the at least one section with the at least one element of the at least one application can be stored on a memory device coupled with a computing device the proposed system is configured with to enable automatic retrieval of the pre-configured dataset.

In an embodiment, the system 100 can control at least one parameter associated with the at least one element of the at least one application. The at least one parameter can pertain to a function of the application such that controlling of the at least one parameter can enable effective control over the function of the application. For instance, the system 100 can control an image capturing device, for instance, a camera coupled with the system 100 so as to control the image camera device to toggle between an image capturing mode and a video capturing mode of the image camera device. In an exemplary aspect, parameter(s) associated with element(s) can be configured to start/stop recording video, target tracking, geotagging, along with performing any other associated function.

As would further be appreciated, elements of a particular section of the display screen can be associated with that section such that when one section is hidden, elements of that section also gets hidden.

In an embodiment, the system 100 can allow concurrent switching of position of different sections of the plurality of sections associated with the at least one element of the currently executed application for simultaneous representation of various information on the display screen in split-screen view.

In an aspect, the system 100 can display the at least one element of the at least one application on the display screen. In an embodiment, the system 100 can simultaneously display the at least one element of at least one application in one or more sections on the display screen in split-screen view. In an exemplary implementation, in the said split-screen view, one of the view would be a video showing view i.e. at least one view would show a video/video stream/a set of video frames.

In another exemplary implementation, in contrast to the prior art solutions where when a video screen is reduced in size by the cursor, in most UAV GUIs, even though the video screen shrinks—the entire video shrinks with it and so the important features from the video also shrinks and one cannot know what is happening in the video, in the proposed method, since the GUI streams the real-time video directly from the UAV camera when the video screen is shrunk with the cursor in the GUI, the video is automatically cropped to show the center field-of-view of the UAV camera, which usually shows the most crucial happenings on the ground through video. In an exemplary aspect, such shrinking of the video can be done for any or a combination of a real-time video that is streaming and/or for a replay video that is playing in one section. The video would, during such shrinking operation, automatically get cropped so as to show/play/display the middle portion of the video. In the case of a real-time streaming video, this middle portion can actually be the video portion that is captured by the center field of view of the camera.

In yet another exemplary implementation, when more than one UAVs fly, video streams from multiple UAVs can be shown as a split-view screen.

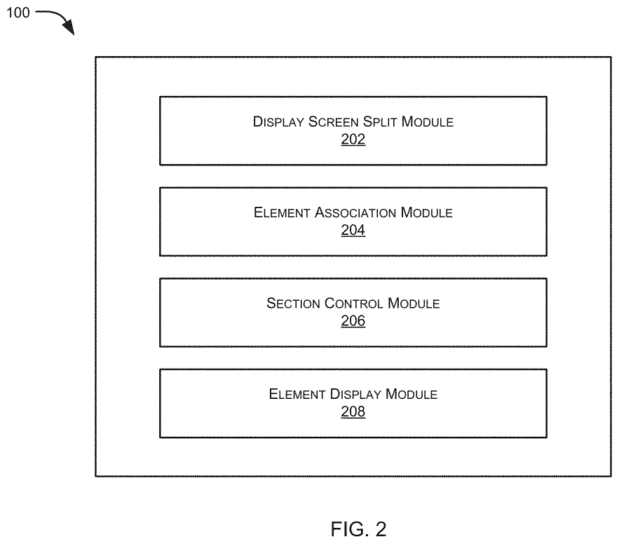

FIG. 2 illustrates an exemplary representation of various modules of proposed system for displaying a plurality of elements of at least one application on a display screen 104 in accordance to an embodiment of the present disclosure.

In an aspect, the system 100 can include a display screen split module 202 to enable splitting of a display screen 104 into plurality of sections. In an embodiment, the display screen split module 202 can receive set of commands pertaining to splitting of display screen 104 into the plurality of sections for displaying at least one element of a plurality of elements of at least one application in split-screen view. In an embodiment, the set of commands pertaining to the splitting of the display screen 104 can be based on a user input, for instance, touch input, gesture input, mouse input and the like input techniques. In an embodiment, the plurality of elements can include information pertaining to at least one function of the at least one application.

In an embodiment, display screen split module 202 can enable splitting of a display region of the display screen 104 into the plurality of sections so as to enable simultaneous displaying of at least one element of a single application in each of the plurality of sections. In another embodiment, the display screen split module 202 can enable splitting of the display region of the display screen 104 into the plurality of sections to enable simultaneous displaying of at least one element of multiple applications in each of the plurality of sections.

In an aspect, the system 100 can further include an element association module 204 for associating at least one section of the plurality of section with at least one element of the plurality of elements of at least one application.

In an embodiment, the association module 204 can assign each section of the plurality of sections with at least one element of the plurality of elements of a single application based on any or a combination of a set of instructions derived from a user and a pre-configured dataset pertaining to association of the at least one section with the at least one element of the single application. In another embodiment, the association module 204 can associate each section of the plurality of sections with at least one element of multiple applications based on any or a combination of the set of instructions derived from the user and the pre-configured dataset pertaining to association of the at least one section with the at least one element of the multiple applications.

In an embodiment, the set of instructions derived from the user can be in the form of any or a combination of a touch input, a gesture input and a mouse input and other like input techniques. In an embodiment, the pre-configured dataset pertaining to association of the at least one section with the at least one element of the at least one application can be stored on a memory device coupled with the computing device 102 the proposed system is configured with to enable automatic retrieval of the pre-configured dataset to enable association of the at least one section with the at least one element of the at least one application.

In an aspect, the proposed system can further include a section control module 206 for controlling at least one display parameter of at least one section of the plurality of sections of display screen 104. In an embodiment, the section control module 206 can modify the at least one display parameter of the at least one section based on any or a combination of a set of instructions derived from the user and pre-defined dataset pertaining to modulation of the at least one display parameter of the at least one section. In an embodiment, the at least one display parameter can be any or a combination of pixel density, height, width, scaling ratio, pixel location and the like parameters of at least one section.

In an embodiment, the set of instructions derived from the user can be in the form of any or a combination of a touch input, a gesture input and a mouse input and other like input techniques. In an embodiment, the pre-configured dataset pertaining to modulation of the at least one display parameter of the at least one section can be stored on the memory device coupled with the computing device 102 the proposed system is configured with to enable automatic retrieval of the pre-configured dataset to enable modulation of the at least one display parameter of the at least one section.

In an embodiment, the section control module 206 can control at least one parameter associated with the at least one element (also referred to as “element parameter” hereinafter) of the at least one application. The at least one parameter can pertain to a function of the application such that controlling of the at least one parameter can enable effective control over the function of the application. For instance, the section control module 206 can control displaying of geographical location of an asset displayed on the display screen 104 so as to allow switching between displaying a location address of the asset and displaying latitude and longitude of the asset.

In an embodiment, the section control module 206 can assign a master control element to allow modulation of parameters associated with elements of all the sections present on the entire display region of the display screen 104. The master control element can include a plurality of master control sub-elements, each configured to modulate element parameters of the plurality of sections. In an embodiment, the section control module 206 can assign a slave control element with each section to allow modulation of the element parameters of each section. The control element can include a plurality of slave control sub-elements, each configured to modulating at least one element parameter of each section of the display screen 104.

In an embodiment, the section control module 206 can allow switching of position of different sections of the plurality of sections associated with the at least one element of the currently executed application for simultaneous representation of various information on the display screen 104 in split-screen view.

In an embodiment, the section control module 206 is further configured to control positioning of the at least one section to a desired location of the display screen 104. The section control module 206 can control positioning of the at least one section by adjusting and/or modulating the instantaneous position of the at least one section on the display region of the display screen 104.

In an aspect, the system 100 can further include an element display module 208 is configured to display the at least one element of the at least one application on the display screen 104. In an embodiment, the element display module 208 can simultaneously display the at least one element of at least one application in one or more sections on the display screen 104 in split-screen view.

In an embodiment, the element display module 208 can enable displaying of at least one element of a single application on the display screen 104. In an embodiment, the element display module 208 can enable displaying of at least one element of multiple applications on the display screen 104.

In an exemplary implementation, in the said split-screen view, one of the view would be a video showing view i.e at least one view would show a video/video stream/a set of video frames.

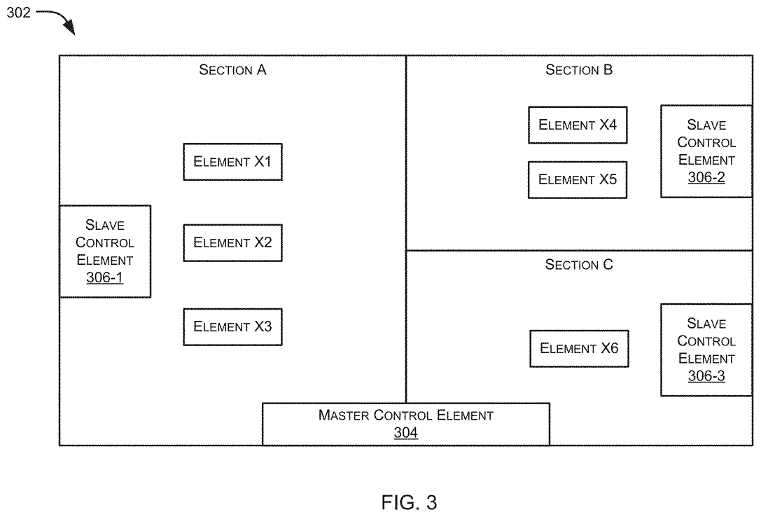

FIG. 3 illustrates an exemplary representation of the plurality of elements of a single application, say application X, displayed on the display screen in accordance to an embodiment of the present disclosure. In an aspect, a display screen 302 can be split into three sections—section A, section B, and section C. The multiple sections of the screen 302 can include a plurality of elements of the application X that represent various information pertaining to at least one function of the application X. As shown, Section A can be associated with elements X1, X2 and X3 of the application X. Likewise, section B can be associated with elements X4 and X5, and section C can be associated with an element X6. In an embodiment, the elements shown on the screen in split-screen view in sections A, B and C are the elements of the application X so that user can analyse different information related to the application X simultaneously. In an embodiment, the display screen 302 can be further split into more number of sections to allocate new sections on the display region of the display screen 302. In an aspect, the display region of the display screen 302 can further be allocated to allocate one or more new sections with the plurality of existing sections. In an embodiment, the newly inserted sections can include different display parameters.

In an embodiment, the allocation of at least one section of the plurality of section with one or more element of plurality of elements is based on any or a combination of a set of instructions derived from a user and a pre-configured dataset pertaining to association of the at least one section with the at least one element of the application.

In an embodiment, the display screen 302 can include a master control element 304 to allow modulation of element parameters pertaining to a function of the application. The master control element 304 can include a plurality of master control sub-elements, each configured to modulate an element parameter of elements of sections A, B and C altogether.

In an embodiment, the display screen 302 can associate a slave control element 306-1 to section A, slave control element 306-2 to section B and slave control element 306-3 to section C to allow modulation of element parameters of each of the sections. The slave control elements 306-1, 306-2 and 306-3 can include a plurality of slave control sub-elements, each configured to modulate an element parameter of corresponding section.

In an embodiment, the master control element and the slave control element can include any or a combination of touch control, gesture control, mouse control, button control and the like input controls.

It would be appreciated that although embodiments of the present disclosure is explained in terms of displaying elements of a single application on a display screen, the scope of the present disclosure is not limited to the any in any way whatsoever, and any other form of system, device or process that involves displaying elements of multiple applications on the display screen is well within the scope of the present disclosure.

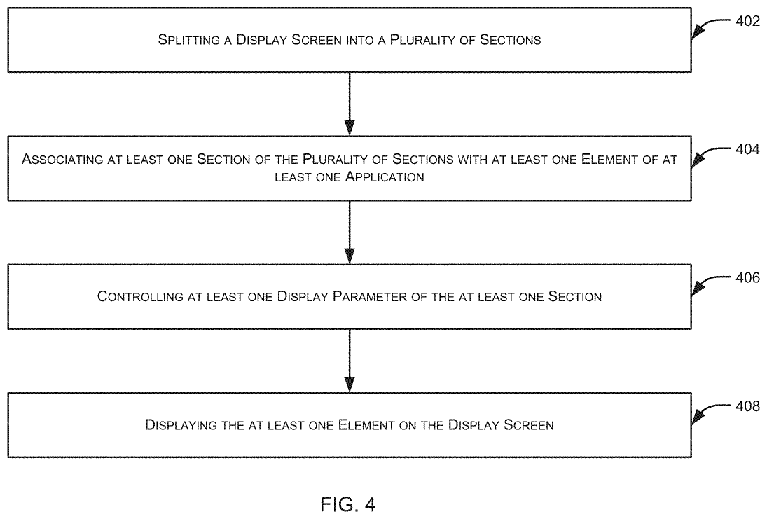

FIG. 4 illustrates an exemplary representation of proposed method for displaying the plurality of elements of the at least one application on the display screen in accordance to an embodiment of the present disclosure. In an aspect, the proposed method 400 can include at step 402, splitting, at a computing device, the display screen into a plurality of sections. In an embodiment, said splitting can be based on a set of commands received in the form of a user input, for instance, touch input, gesture input, mouse input and the like input techniques.

In an aspect, the method can include at step 402, associating, at the computing device, at least one section of the plurality of sections with at least one element of the plurality of elements of the at least one application. In an embodiment, said association can be based on any or a combination of a set of instructions derived from a user and a pre-configured dataset pertaining to association of the at least one section with the at least one element. In an embodiment, the set of instructions derived from the user can be in the form of any or a combination of a touch input, a gesture input and a mouse input and other like input techniques. In an embodiment, the pre-configured dataset pertaining to association of the at least one section with the at least one element of the at least one application can be stored on a memory device coupled with the computing device to enable automatic retrieval of the pre-configured dataset.

In an aspect, the method can include at step 406, controlling, at the computing device, at least one display parameter of the at least one section. In an embodiment, the at least one display parameter can include any or a combination of pixel density, height, width, scaling ratio, pixel location and the like parameters of at least one section.

In an embodiment, the step of controlling the at least one display parameter of the at least one section can further include positioning of the at least one section to a desired location of the display region of the display screen based on any or combination of the set of instructions derived from the user and the pre-configured dataset.

In an aspect, the method can include at step 406, displaying, at the computing device, the at least one element on the display screen in split-screen view. In an embodiment, multiple elements of an application can be simultaneously displayed in the at least one section of a display region of the display screen.

In an embodiment, the method can further include a step of controlling at least one parameter associated with the at least one element of the at least one application.

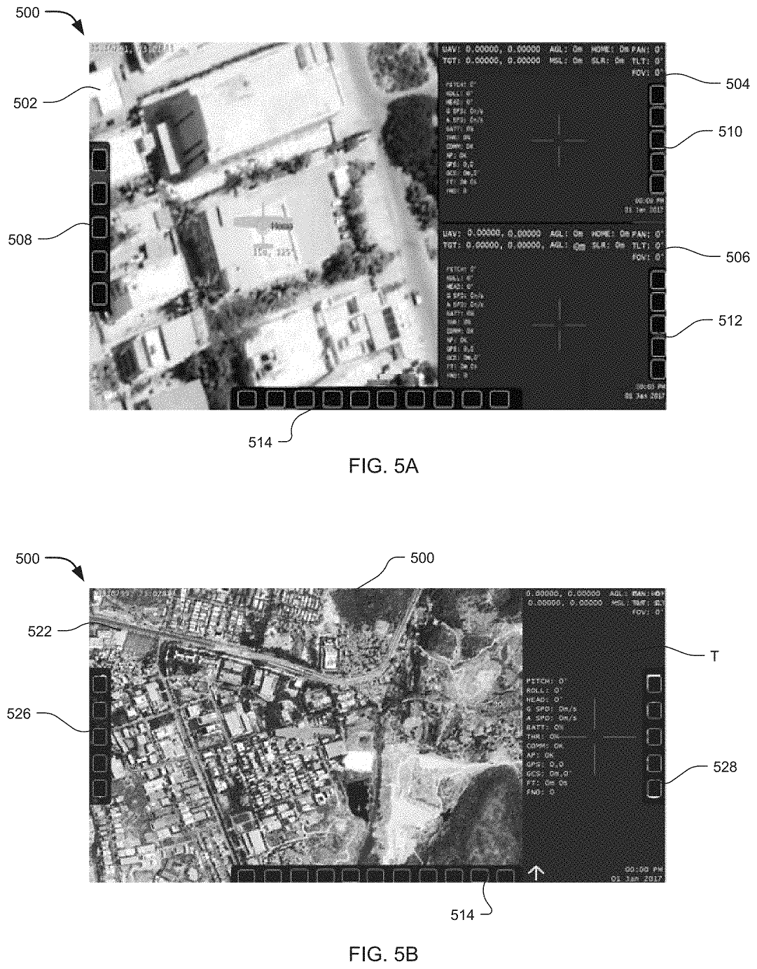

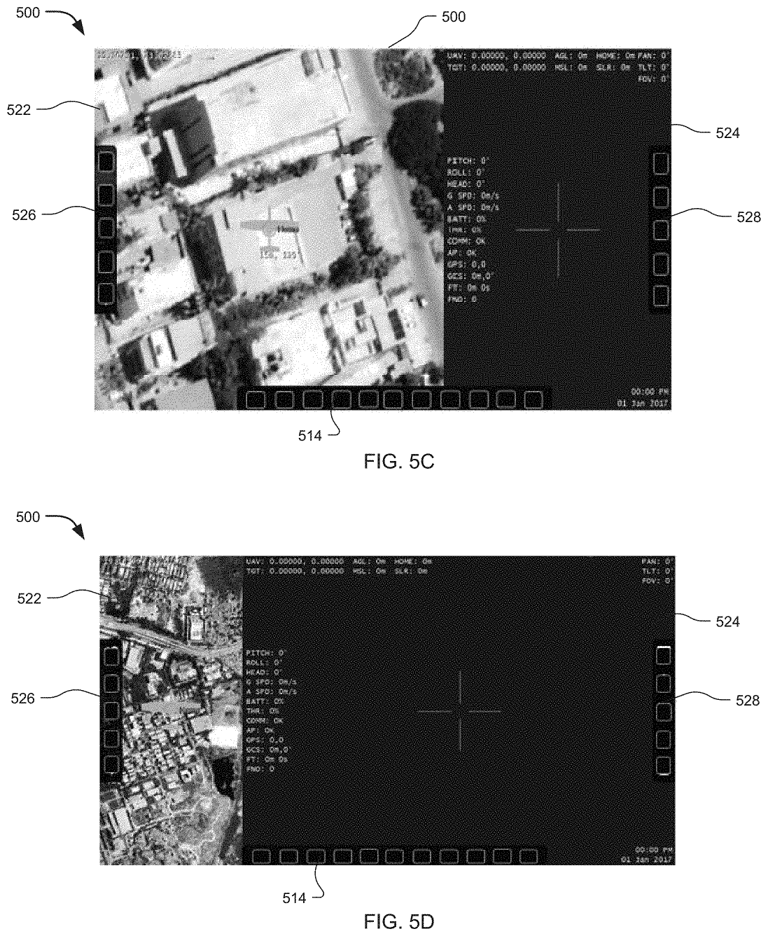

FIGS. 5A through 5D illustrate exemplary photographic representations showing a display screen displaying multiple elements of an application in split-screen view in accordance with embodiments of the present disclosure. In an aspect, FIGS. 5A through 5D illustrate various representations of a display screen of an unmanned aerial vehicle (UAV) navigation application used to analyse various information pertaining to a navigation area that the UAV is navigating. In an embodiment, FIG. 5A illustrates a display region 500 of the display screen that includes three section—section 502, section 504 and section 506 in split-screen view. In an embodiment, the three sections of the display region 500 of the display screen are associated with different elements of the navigation application. In an embodiment, section 502 displays a navigation map of the navigation area. Section 504 displays a day-light camera video of the navigation area. Section 506 displays a thermal camera video of the navigation area.

FIGS. 5B through 5D illustrate division of the display region 500 into two sections—section 522 and section 524 in split-screen view. In an embodiment, section 522 displays a navigation map of a zoomed out view of the navigation area and section 524 display the day-light camera video of the zoomed out navigation area. As illustrated in FIGS. 5C and 5D, height and width of any of the sections can be adjusted and display parameters of any of the sections can be modulated as per requirement of a user.

In an embodiment, each section of the display region 500 can be associated with respective slave control elements. For instance, section 502, 504 and 506 (as show in FIG. 5A) can be associated with a slave control elements 508, 510 and 512 respectively. Likewise, sections 522 and 524 can be associated with slave control elements 526 and 528 respectively. Each slave control elements can include a plurality of slave control sub-elements configured to control modulation of any or a combination of at least one display parameter and function of respective sections.

In an embodiment, the display region 500 can be associated with a master control element 514 configured to control modulation of any or a combination of at least one display parameter and element parameter of the display region. In an embodiment, the master control element 514 can include a plurality of master control sub-elements configured to control modulation of any or a combination of the at least one display parameter and element parameter of the elements of all the sections.

In an embodiment, any of the master control element and the slave control element can be used to control modulation of element parameters as well as display parameters of each of the sections. In an instance, height and width of any of the sections can be adjusted by implementing edge-wise modulation that involves using the graphical user interface (GUI) of the display region 500 to extend and/or contract an edge of a section in order to modulate the height and/or width of the section. In another instance, the master control element can be configured to change orientation of an asset displayed in a section of the display screen to allow a displaying of a desired orientation of the asset on the display screen.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### Advantages of the Invention

The present disclosure provides system and method for displaying of a plurality of elements of an application on a display screen in split-screen view.

The present disclosure provides system and method for positioning of a plurality of sections of a display region of the display screen.

The present disclosure provides system and method incorporating control options for modification of various display parameters of the display screen.

The present disclosure provides convenient and user friendly system and method for simultaneously displaying the elements of an application on the display screen.

We claim:

1. A method for displaying a plurality of elements of at least one application on a display screen that is associated with a UAV ground control system, the method comprising the steps of:
splitting, at a computing device, the display screen into a plurality of sections;
associating, at the computing device, at least one section of the plurality of sections with at least one element of the plurality of elements, wherein the association is based on any or a combination of a set of instructions derived from a user and a pre-configured dataset pertaining to association of the at least one section with the at least one element;
controlling, at the computing device, at least one display parameter of the at least one section; and
displaying, at the computing device, the at least one element of the at least one application on the display screen.

2. The method of claim 1, wherein the plurality of elements comprise a video, and wherein said video is streamed in real-time directly from camera associated with the UAV such that when the display screen is shrunk, the video is automatically cropped so as to show center field-of-view of the camera.

3. The method of claim 1, further comprising a step of positioning the at least one section to a desired location of the display screen, said at least one section displaying a video frame.

4. The method of claim 1, further comprising a step of controlling at least one parameter associated with the at least one element of the at least one application.

5. The method of claim 1, wherein the at least one display parameter comprises any or a combination of pixel density, height, width, scaling ratio and pixel location of the at least one of the plurality of sections.

6. A system comprising:
a non-transitory storage device having embodied therein one or more routines operable to display a plurality of elements of at least one application on a display screen; and
one or more processors coupled to the non-transitory storage device, wherein the one or more routines include:
a display screen split module, which when executed by the one or more processors, splits the display screen into a plurality of sections;
an element association module, which when executed by the one or more processors, associates at least one section of the plurality of sections with at least one element of the plurality of elements, wherein the association is based on any or a combination of a set of instructions derived from a user and a pre-configured dataset pertaining to association of the at least one section with the at least one element;
a section control module, which when executed by the one or more processors, controls at least one display parameter of the at least one section; and
an element display module, which when executed by the one or more processors, displays the at least one element of the at least one application on the display screen.

7. The system of claim 6, wherein the section control module is configured to position the at least one section to a desired location of the display screen, said at least one section displaying a video frame.

8. The system of claim 6, wherein the at least one display parameter comprises any or a combination of pixel density, height, width, scaling ratio and pixel location of the at least one of the plurality of sections.

9. The system of claim 6, wherein the section control module is configured to control at least one parameter associated with the at least one element of the at least one application.

10. The system of claim 6, wherein the element display module simultaneously displays the at least one element in split-screen view.

11. The system of claim 6, wherein the section control module allows switching of position of different sections of the plurality of sections.

12. The system of claim 6, wherein the plurality of elements comprise a video, and wherein said video is streamed in real-time directly from camera associated with the UAV such that when the display screen is shrunk, the video is automatically cropped so as to show center field-of-view of the camera.
